(19) United States
(12) Patent Application Publication
(10) Pub. No.: US 2025/0104354 A1
(43) Pub. Date: Mar. 27, 2025

(54) VIRTUAL OBJECT GENERATION METHOD AND APPARATUS, DEVICE, AND STORAGE MEDIUM

(71) Applicant: Beijing Zitiao Network Technology Co., Ltd., Haidian District, Beijing (CN)

(72) Inventors: Jiacheng Liu, Beijing (CN); Xiaoxing Chen, Beijing (CN)

(21) Appl. No.: 18/730,187

(22) PCT Filed: Jan. 12, 2023
(86) PCT No.: PCT/CN2023/071876

§ 371 Date: Jul. 18, 2024

(30) Foreign Application Priority Data
Jan. 21, 2022 (CN) 202210073858.5

(51) Int. Cl. G06T 17/20; G06V 10/25

(52) U.S. Cl. CPC G06T 17/20; G06V 10/25; G06V 2201/07

(57) ABSTRACT

The present disclosure provides a virtual object generation method and apparatus, a device and a storage medium. The virtual object generation method includes: acquiring a virtual object box to be mounted; generating a reference line based on the virtual object box; determining a position relationship between the reference line and a rendered virtual object; processing the virtual object box according to the position relationship; and generating a virtual object in the processed virtual object box.

### CROSS-REFERENCE TO RELATED APPLICATION(S)

The present application claims the priority to Chinese Application No. 202210073858.5, filed in the China Patent Office on Jan. 21, 2022, and the disclosure of which is incorporated herein by reference in its entity.

### FIELD

The present disclosure relates to the technical field of augmented reality, for example, to a virtual object generation method and apparatus, a device and a storage medium.

### BACKGROUND

When virtual objects are generated in a real scenario, when the virtual objects are directly generated according to virtual object boxes returned by an algorithm, an overlapping phenomenon of the virtual objects may be generated. In addition, when the virtual objects in the current picture are updated, if screen cleaning processing is performed on the virtual objects, and then new virtual objects are generated, pictures generated by the virtual objects may be discontinuous, thus affecting the user experience.

### SUMMARY

The present disclosure provides a virtual object generation method and apparatus, a device and a storage medium, so as to not only avoid the overlapping of virtual objects, but also ensure the smooth generation of the virtual objects, thereby improving the user experience.

In a first aspect, the present disclosure provides a virtual object generation method, including:
acquiring a virtual object box to be mounted;
generating a reference line based on the virtual object box;
determining a position relationship between the reference line and a rendered virtual object;
processing the virtual object box according to the position relationship; and generating a virtual object in the processed virtual object box.

In a second aspect, the present disclosure further provides a virtual object generation apparatus, including:
a virtual object box acquiring module, configured to acquire virtual object box to be mounted;
a reference line generating module, configured to generate a reference line based on the virtual object box;
a position relationship determining module, configured to determine a position relationship between the reference line and a rendered virtual object;
a virtual object box processing module, configured to process the virtual object box according to the position relationship; and
a virtual object generating module, configured to generate a virtual object in the processed virtual object box.

In a third aspect, the present disclosure further provides an electronic device, including:
one or more processing units; and
a storage unit, configured to store one or more programs, wherein
when the one or more programs are executed by the one or more processing units, the one or more processing units implement the above virtual object generation method.

In a fourth aspect, the present disclosure discloses a computer-readable medium, on which a computer program is stored, wherein the program implements, when being executed by a processing unit, the above virtual object generation method.

In a fifth aspect, the present disclosure further provides a computer program product, including a computer program carried on a non-transient computer-readable medium, wherein the computer program includes program codes for implementing the above virtual object generation method.

### BRIEF DESCRIPTION OF THE DRAWINGS

FIG. 1 is a flowchart of a virtual object generation method provided in an embodiment of the present disclosure;

FIG. 2 is an example diagram of an acquired virtual object box provided in an embodiment of the present disclosure;

FIG. 3 is a schematic diagram of the pinhole camera imaging principle provided in an embodiment of the present disclosure;

FIG. 4 is an example diagram of performing triangular meshing on the surface of a rendered virtual object provided in an embodiment of the present disclosure;

FIG. 5 is an example diagram of generating virtual objects provided in an embodiment of the present disclosure;

FIG. 6 is a schematic structural diagram of a virtual object generation apparatus provided in an embodiment of the present disclosure; and

FIG. 7 is a schematic structural diagram of an electronic device provided in an embodiment of the present disclosure.

### DETAILED DESCRIPTION OF EMBODIMENTS

Embodiments of the present disclosure will be described below with reference to the drawings. Although some embodiments of the present disclosure are shown in the drawings, the present disclosure may be implemented in various forms, and these embodiments are provided for understanding the present disclosure. The drawings and embodiments of the present disclosure are for illustrative purposes only.

A plurality of steps recorded in method embodiments of the present disclosure may be executed in different sequences and/or in parallel. In addition, the method embodiments may include additional steps and/or omit executing the steps shown. The scope of the present disclosure is not limited in the this aspect.

As used herein, the terms “include” and variations thereof are open-ended terms, i.e., “including, but not limited to”. The term “based on” is “based, at least in part, on”. The term “one embodiment” means “at least one embodiment”; the term “another embodiment” means “at least one additional embodiment”; and the term “some embodiments” means “at least some embodiments”. Relevant definitions of other terms will be given in the following description.

Concepts such as “first” and “second” mentioned in the present disclosure are only intended to distinguish different apparatuses, modules or units, and are not intended to limit the sequence or interdependence of the functions executed by these apparatuses, modules or units.

The modifiers of “one” and “more” mentioned in the present disclosure are illustrative and not restrictive, and those skilled in the art should understand that the modifiers should be interpreted as “one or more” unless the context clearly indicates otherwise.

The names of messages or information interacted between a plurality of apparatuses in the embodiments of the present disclosure are for illustrative purposes only and are not intended to limit the scope of these messages or information.

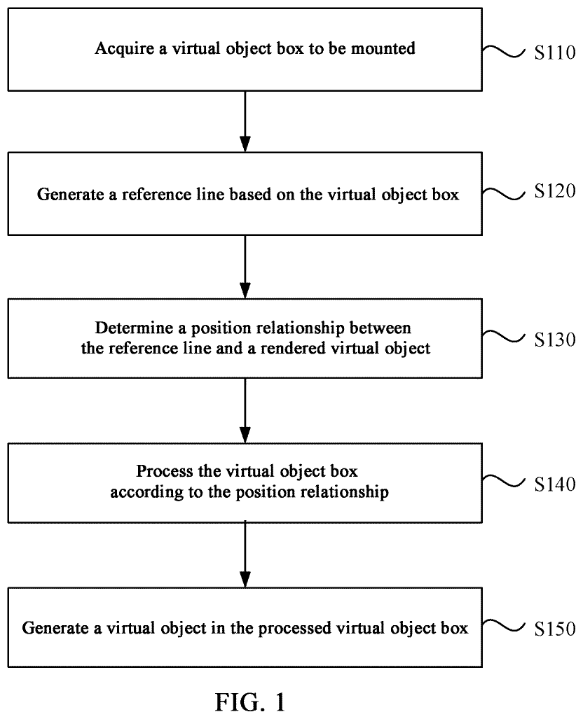

FIG. 1 is a flowchart of a virtual object generation method provided in an embodiment of the present disclosure, the present embodiment may be applied to a case where virtual objects are generated in a picture of a three-dimensional space, the method may be executed by a virtual object generation apparatus, the apparatus may be composed of hardware and/or software, and may generally be integrated into a device having a virtual object generation function, and the device may be an electronic device such as a server, a mobile terminal, or a server cluster. As shown in FIG. 1, the method includes the following steps:

S110, acquiring a virtual object box to be mounted.

The virtual object box is suspended on a object identified in a three-dimensional space for placing virtual objects, and there may be a plurality of virtual object boxes. In the present embodiment, the virtual object may be a virtual object corresponding to any theme, for example, a “Spring Festival” theme, then the virtual object may be a virtual antithetical couplet, a virtual lantern, a virtual New Year picture, and the like, which is not limited herein.

The manner of acquiring the virtual object box to be mounted may be: performing object detection on the current picture; and determining the virtual object box according to detected object.

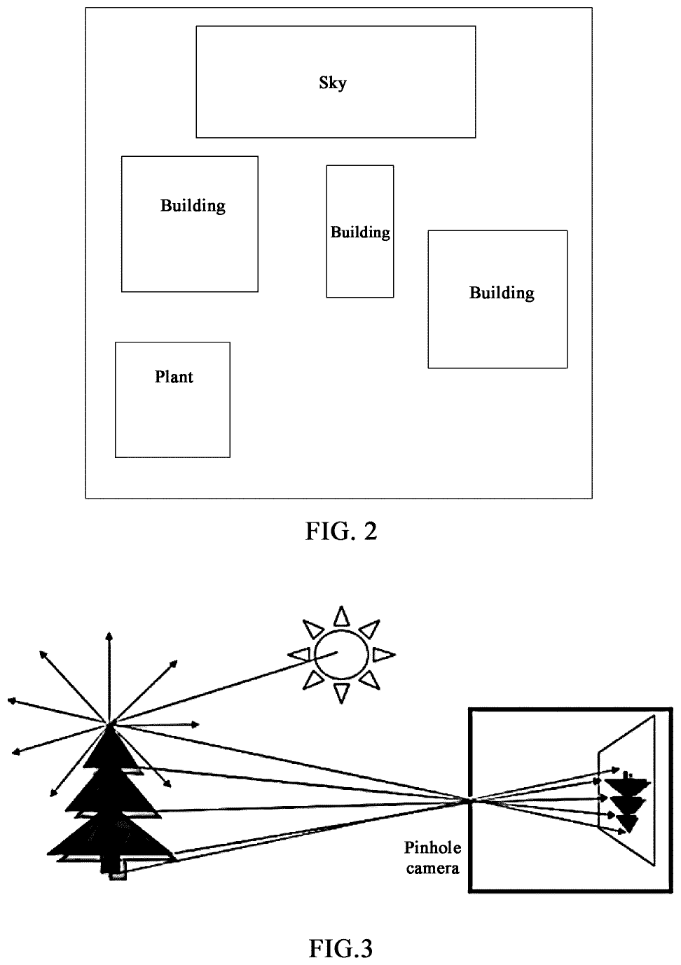

In the present embodiment, during the process of a terminal deice photographing the current three-dimensional space, an object detection module in the terminal device detects objects in the picture according to a certain frequency, so as to obtain detection boxes and semantic information, which correspond to the objects, and determines virtual object boxes according to the detection boxes and the semantic information. Exemplarily, FIG. 2 is an example diagram of an acquired virtual object box provided in an embodiment of the present disclosure, as shown in FIG. 2, objects detected in the picture includes a sky, buildings and a plant, and virtual object boxes are generated on these objects.

The sizes of the virtual object box may be determined according to the detection boxes of the objects, and the categories of the virtual object box may be determined according to the semantic information. The sizes of the virtual object box may be less than or equal to the detection boxes of the objects, or the detection boxes of the objects are split to obtain a plurality of virtual object box. The categories of the virtual object box are used for determining the categories of internal virtual objects, and the categories may include a static virtual object and a dynamic virtual object. Exemplarily, taking the “Spring Festival” theme as an example, the static virtual object may be an “antithetical couplet”, and the dynamic virtual object may be a “rotating lantern”. In the present embodiment, the virtual object box are determined according to the detected objects, so that the virtual objects placed in the virtual object box are more adapted to the real scenario.

S120, generating a reference line based on the virtual object box.

The reference lines may be rays emitted from the virtual object boxes, and the reference lines based on the virtual object boxes may be generated according to the camera imaging principle. The camera imaging principle may be the pinhole camera imaging principle, exemplarily, FIG. 3 is a schematic diagram of the pinhole camera imaging principle provided in an embodiment of the present disclosure, as shown in FIG. 3, light reflected by an object in the three-dimensional space enters a pinhole camera, the pinhole camera projects a collected image onto a pixel plane, and each pixel point on the pixel plane may generate a reference line directed towards the three-dimensional space in a direction opposite to the rays. In the present embodiment, the acquired virtual object boxes are located in the pixel plane, set pixel points may be selected on the virtual object boxes, the reference lines directed towards the three-dimensional space are generated from these set pixel points in the direction opposite to the rays, and direction vectors of these reference lines may be acquired according to the inverse transform principle of the pinhole camera.

Each virtual object box includes vertex information and central point information of the virtual object box, and there are a plurality of vertexes. The manner of generating the reference line based on the virtual object box may be: generating a plurality of reference lines respectively corresponding to the plurality of vertices and a central point.

In the present embodiment, each virtual object box may be a parallelogram, and then the virtual object box includes four vertices. In the present application scenario, five reference lines emitted from the four vertices and the center line of the virtual object box are respectively generated according to the camera imaging principle, and the direction vectors of the five reference lines may be obtained according to the inverse transform principle of the pinhole camera. In the present embodiment, by means of generating the plurality of reference lines respectively corresponding to the plurality of vertexes and the central point, the calculation amount may be reduced.

In the present embodiment, a reference line generation component (rayCast component) may be added into a camera, the component is configured to generate the reference lines emitted from the four vertices and the central point of the virtual object box according to the camera imaging principle.

S130, determining a position relationship between the reference line and a rendered virtual object.

The rendered virtual object may be understood as a virtual object, which has been displayed and mounted on an object in the three-dimensional space, and the virtual object is a three-dimensional (3D) object. The position relationship include intersection and non-intersection.

determining the position relationship between the reference line and the rendered virtual object includes: determining distances, to the rendered virtual object, from the plurality of reference lines respectively corresponding to the plurality of vertices and the central point; if the distances are less than or equal to a set value, the reference lines intersect with the rendered virtual object; and if the distances are greater than the set value, the reference lines do not intersect with the rendered virtual object.

The position relationship between the reference line and the rendered virtual object include a position relationship of the reference lines corresponding to the four vertices with the rendered virtual object, and a position relationship of the reference line corresponding to the central point with the rendered virtual object.

The set value may be a 0. The distances from the reference lines to the rendered virtual object may be understood as a shortest distance from a plurality of points on the surface of the rendered object to the reference lines, and if the shortest distance is greater than 0, it indicates that the reference lines do not intersect with the rendered object, and if the shortest distance is less than or equal to 0, it indicates that the reference lines intersect with the rendered object. In the present implementation, the position relationship is determined based on the distances from the reference lines and the rendered virtual object, so that whether the reference lines intersect with the rendered object can be quickly and accurately determined.

S140, processing the virtual object box according to the position relationship.

The processing manner may be deleting or lowering the transparency.

The manner of processing the virtual object box according to the position relationship may be: if the reference lines corresponding to the central point intersect with the rendered virtual object, deleting the virtual object box or lowering the transparency of the virtual object box; and if the reference lines corresponding to the central point do not intersect with the rendered virtual object, and the reference lines corresponding to vertexes exceeding a set number intersect with the rendered virtual object, deleting the virtual object box or lowering the transparency of the virtual object box.

The set number may be set to be 2 or 3. In the present embodiment, if the reference lines corresponding to the central point intersect with the rendered virtual object, it indicates that the virtual objects in the virtual object boxes completely overlap with the rendered virtual object, therefore it is necessary to delete or lower the transparency of the virtual object boxes. If the reference lines corresponding to the vertexes exceeding the set number intersect with the rendered virtual object, it indicates that the virtual objects in the virtual object boxes will overlap with the rendered virtual object to a greater extent, therefore it is also necessary to delete or lower the transparency of the virtual object boxes. In this way, the accuracy of processing the virtual object boxes can be improved.

The manner of determining the position relationship between the reference line and the rendered virtual object may be: performing triangular meshing on the surface of the rendered virtual object, so as to obtain a plurality of triangular planes; respectively determining intersection conditions between the reference lines and the plurality of triangular planes; and if the reference lines intersect with any triangular plane, the reference lines intersect with the rendered virtual object.

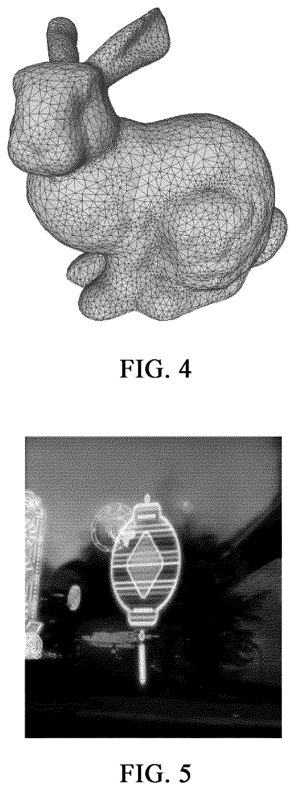

The rendered virtual object is a three-dimensional object, and performing triangular meshing on the surface of the rendered virtual object may be understood as dividing the surface of the rendered virtual object into a plurality of triangular planes. Exemplarily, FIG. 4 is an example diagram of performing triangular meshing on the surface of the rendered virtual object provided in an embodiment of the present disclosure, as shown in FIG. 4, the virtual object is a three-dimensional rabbit, and the surface of the object is divided into a plurality of triangular planes. The manner of determining the intersection conditions between the reference lines and the plurality of triangular planes may be implemented by using the principle of intersection between straight lines and triangular planes, which is not limited herein.

In the present embodiment, after the plurality of triangular planes are obtained, the intersection conditions of the plurality of reference lines respectively corresponding to the plurality of vertexes and the central point with each triangular plane are determined, and if the reference lines intersect with any triangular plane, it indicates that the reference lines intersect with the rendered virtual object. In the present embodiment, the intersection conditions between the reference lines and the rendered virtual object are determined by means of performing triangular meshing on the surface of the rendered virtual object, such that the accuracy can be improved.

The manner of determining the position relationship between the reference line and the rendered virtual object may be: acquiring a bounding box of the rendered virtual object; determining intersection conditions between the reference lines and the bounding box; and if the reference lines intersect with the bounding box, the reference lines intersect with the rendered virtual object.

The bounding box is a cuboid, which may be understood as a minimum bounding cuboid of the rendered virtual object. The cuboid includes three pairs of parallel surfaces, which are respectively front and back parallel surfaces, left and right parallel surfaces, and upper and lower parallel surfaces.

The process of determining the intersection conditions between the reference lines and the bounding box may be: acquiring three line segments obtained by the intersection of the reference lines with the three pairs of parallel surfaces corresponding to the bounding box; and if all the three line segments meet the following condition, the reference lines intersect with the bounding box: a part or entirety of each line segment falls into the bounding box.

The three pairs of parallel surfaces corresponding to the bounding box may be understood as planes extending to the entire space from the three pairs of parallel surfaces corresponding to the bounding box, including the front and back parallel surfaces extending to the entire space, the left and right parallel surfaces extending to the entire space, and the upper and lower parallel surfaces extending to the entire space. For each pair of parallel surfaces, the reference lines intersect with the pair of parallel surfaces to obtain one line segment, and thus three line segments are obtained. In the present embodiment, according to the direction vectors of the reference lines and a spatial function of each pair of parallel surfaces, coordinates of two endpoints of the line segment formed after the reference lines intersect with the parallel surfaces may be obtained, and whether a part or entirety of the line segment falls into the bounding box may be determined according to the coordinates of the two endpoints. In the present embodiment, the intersection conditions between the reference lines and the rendered virtual object are determined based on the intersection conditions between the reference lines and the bounding box, so that the efficiency of determining the position relationship can be improved.

In the present embodiment, if the reference line intersects with the rendered virtual object, it indicates that the virtual object in the virtual object box intersecting with the reference line partially or completely overlaps with the rendered virtual object, therefore it is necessary to delete the virtual object box or lower the transparency of the virtual object box, and it is not necessary to render the virtual object in the processed virtual object box.

S150, generating a virtual object in the processed virtual object box.

After the virtual object boxes colliding with the rendered virtual object are deleted or lowered in transparency, the remaining virtual object boxes are mounted on corresponding objects in the three-dimensional space at first, then materials corresponding to the remaining virtual object boxes are acquired, and the materials are rendered in the remaining virtual object boxes, so as to generate virtual objects. Exemplarily, FIG. 5 is an example diagram of generating virtual objects provided in an embodiment of the present disclosure, and as shown in FIG. 5, a “virtual New Year picture” and a “virtual rotating lantern” are generated.

In the technical solution of the embodiment of the present disclosure, virtual object box to be mounted is acquired; reference line is generated based on the virtual object box; position relationship between the reference line and a rendered virtual object is determined; the virtual object box is processed according to the position relationship; and virtual object is generated in the processed virtual object box. In the virtual object generation method provided in the embodiment of the present disclosure, the virtual object box is processed according to the position relationship between the reference line and the rendered virtual object, so that the overlapping of the virtual objects can be prevented; and moreover, the virtual objects may be gradually added, and there is no need to perform screen clearing processing on the virtual objects, so that the smooth generation of the virtual objects can be ensured, thereby improving the user experience.

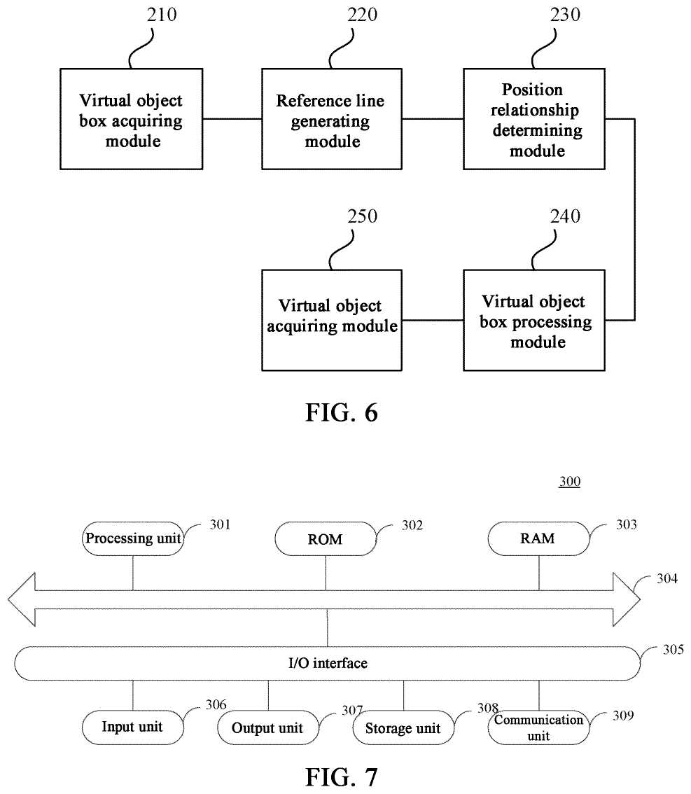

FIG. 6 is a schematic structural diagram of a virtual object generation apparatus provided in an embodiment of the present disclosure, and as shown in FIG. 6, the apparatus includes:

a virtual object box acquiring module 210, configured to acquire virtual object box to be mounted; a reference line generating module 220, configured to generate a reference line based on the virtual object box; a position relationship determining module 230, configured to determine a position relationship between the reference line and a rendered virtual object; a virtual object box processing module 240, configured to process the virtual object box according to the position relationship; and a virtual object generating module 250, configured to generate a virtual object in the processed virtual object box.

In one embodiment, the virtual object box acquiring module 210 is configured to:
perform object detection on the current picture; and determine the virtual object box according to detected object.

In one embodiment, each virtual object box includes vertex information and central point information of the virtual object box, and there are a plurality of vertexes; and the reference line generating module 220 is configured to: generate a plurality of reference lines respectively corresponding to the plurality of vertices and a central point.

In one embodiment, the position relationship determining module 230 is configured to:
determine distances, to the rendered virtual object, from the plurality of reference lines respectively corresponding to the plurality of vertices and the central point; if the distances are less than or equal to a set value, the reference lines intersect with the rendered virtual object; and if the distances are greater than the set value, the reference lines do not intersect with the rendered virtual object.

In one embodiment, the virtual object box processing module 240 is configured to:
if the reference lines corresponding to the central point intersect with the rendered virtual object, delete the virtual object box or lower the transparency of the virtual object box; and if the reference lines corresponding to the central point do not intersect with the rendered virtual object, and the reference lines corresponding to vertexes exceeding a set number intersect with the rendered virtual object, delete the virtual object box or lower the transparency of the virtual object box.

In one embodiment, the position relationship determining module 230 is configured to:
perform triangular meshing on the surface of the rendered virtual object, so as to obtain a plurality of triangular planes; determine intersection conditions between the reference lines and the plurality of triangular planes; and if the reference lines intersect with any triangular plane, the reference lines intersect with the rendered virtual object.

In one embodiment, the position relationship determining module 230 is configured to:
acquire a bounding box of the rendered virtual object; determine intersection conditions between the reference lines and the bounding box; and if the reference lines intersect with the bounding box, the reference lines intersect with the rendered virtual object.

In one embodiment, the position relationship determining module 230 is configured to determine the intersection conditions between the reference lines and the bounding box in the following manner:
acquiring three line segments obtained by the intersection of the reference lines with three pairs of parallel surfaces corresponding to the bounding box; and if all the three line segments meet the following condition, the reference lines intersect with the bounding box: a part or entirety of each line segment falls into the bounding box.

The above apparatus may execute the method provided in all the foregoing embodiments of the present disclosure, and has corresponding functional modules and effects for executing the above method. For technical details that are not described in detail in the present embodiment, reference may be made to the method provided in all the foregoing embodiments of the present disclosure.

Referring to FIG. 7 below, it illustrates a schematic structural diagram of an electronic device 300 suitable for implementing the embodiment of the present disclosure. The electronic device in the embodiment of the present disclosure may include mobile terminals such as mobile phones, notebook computers, digital broadcast receivers, personal digital assistants (PDAs), portable Android devices (PADs), portable media players (PMPs), vehicle-mounted terminals (e.g., vehicle-mounted navigation terminals), and the like, and fixed terminals such as digital television (TVs), desktop computers, and the like, or servers in various forms, such as independent servers or server clusters. The electronic device 300 shown in FIG. 7 is merely an example, and should not bring any limitation to the functions and use ranges of the embodiments of the present disclosure.

As shown in FIG. 7, the electronic device 300 may include a processing unit (e.g., a central processing unit, a graphics processing unit, or the like) 301, and the electronic device may execute various suitable actions and processes in accordance with a program stored in a read-only memory (ROM) 302 or a program loaded from a storage unit 308 into a random access memory (RAM) 303. In the RAM 303, various programs and data needed by the operations of the electronic device 300 are also stored. The processing unit 301, the ROM 302 and the RAM 303 are connected with each other via a bus 304. An input/output (I/O) interface 305 is also connected to the bus 304.

In general, the following apparatuses may be connected to the I/O interface 305: an Input unit 306, including, for example, a touch screen, a touch pad, a keyboard, a mouse, a camera, a microphone, an accelerometer, a gyroscope, and the like; an Output unit 307, including, for example, a liquid crystal display (LCD), a speaker, a vibrator, and the like; a storage unit 308, including, for example, a magnetic tape, a hard disk, and the like; and a communication unit 309. The communication unit 309 may allow the electronic device 300 to communicate in a wireless or wired manner with other devices to exchange data. Although FIG. 7 illustrates the electronic device 700 having various apparatuses, it should be understood that not all illustrated apparatuses are required to be implemented or provided. More or fewer apparatuses may alternatively be implemented or provided.

According to the embodiments of the present disclosure, the processes described above with reference to the flowcharts may be implemented as computer software programs. For example, an embodiment of the present disclosure includes a computer program product, which includes a computer program carried on a computer-readable medium, and the computer program contains program codes for executing a word recommendation method. In such an embodiment, the computer program may be downloaded and installed from a network via the communication unit 309, or installed from the storage unit 308, or installed from the ROM 302. When the computer program is executed by the processing unit 301, the above functions defined in the method of the embodiments of the present disclosure are executed.

The computer-readable medium described above in the present disclosure may be either a computer-readable signal medium or a computer-readable storage medium, or any combination of the two. The computer-readable storage medium may be, for example, but is not limited to, an electrical, magnetic, optical, electromagnetic, infrared, or semiconductor system, apparatus or device, or a combination of any of the above. Examples of the computer-readable storage medium may include, but are not limited to: an electrical connection having one or more wires, a portable computer magnetic disk, a hard disk, an RAM, an ROM, an erasable programmable read-only memory (EPROM or flash memory), an optical fiber, a compact disc read-only memory (CD-ROM), an optical storage device, a magnetic storage device, or any suitable combination of the above. In the present disclosure, the computer-readable storage medium may be any tangible medium that contains or stores a program, wherein the program may be used by or in combination with an instruction execution system, apparatus or device. In the present disclosure, the computer-readable signal medium may include a data signal that is propagated in a baseband or used as part of a carrier, wherein the data signal carries computer-readable program codes. Such propagated data signal may take many forms, including, but not limited to, electromagnetic signals, optical signals, or any suitable combination thereof. The computer-readable signal medium may also be any computer-readable medium other than the computer-readable storage medium, and the computer-readable signal medium may send, propagate or transport the program for use by or in combination with the instruction execution system, apparatus or device. Program codes contained on the computer-readable medium may be transmitted with any suitable medium, including, but not limited to: an electrical wire, an optical cable, radio frequency (RF), and the like, or any suitable combination thereof.

In some embodiments, a client and a server may perform communication by using any currently known or future-developed network protocol, such as a hypertext transfer protocol (HTTP), and may be interconnected with any form or medium of digital data communication (e.g., a communication network). Examples of the communication network include a local area network (LAN), a wide area network (WAN), an international network (e.g., the Internet), and a peer-to-peer network (e.g., an ad hoc peer-to-peer network), as well as any currently known or future-developed network.

The computer-readable medium may be contained in the above electronic device; and it may also be present separately and is not assembled into the electronic device.

The computer-readable medium carries one or more programs that, when being executed by the electronic device, cause the electronic device to perform the following operations: acquiring a virtual object box to be mounted; generating a reference line based on the virtual object box; determining a position relationship between the reference line and a rendered virtual object; processing the virtual object box according to the position relationship; and generating a virtual object in the processed virtual object box.

Computer program codes for executing the operations of the present disclosure may be written in one or more programming languages or combinations thereof. The programming languages include object-oriented programming languages, such as Java, Smalltalk, C++, and conventional procedural programming languages, such as the “C” language or similar programming languages. The program codes may be executed entirely on a user computer, executed partly on the user computer, executed as a stand-alone software package, executed partly on the user computer and partly on a remote computer, or executed entirely on the remote computer or a server. In the case involving the remote computer, the remote computer may be connected to the user computer through any type of network, including an LAN or a WAN, or it may be connected to an external computer (e.g., through the Internet using an Internet service provider).

The flowcharts and block diagrams in the drawings illustrate the system architectures, functions and operations of possible implementations of systems, methods and computer program products according to various embodiments of the present disclosure. In this regard, each block in the flowcharts or block diagrams may represent a part of a module, a program segment, or a code, which contains one or more executable instructions for implementing specified logical functions. It should also be noted that, in some alternative implementations, the functions annotated in the blocks may occur out of the sequence annotated in the drawings. For example, two blocks shown in succession may, in fact, be executed substantially concurrently, or the blocks may sometimes be executed in a reverse sequence, depending upon the functions involved. It should also be noted that each block in the block diagrams and/or flowcharts, and combinations of the blocks in the block diagrams and/or flowcharts may be implemented by dedicated hardware-based systems for executing specified functions or operations, or combinations of dedicated hardware and computer instructions.

The units involved in the described embodiments of the present disclosure may be implemented in a software or hardware manner. The names of the units do not constitute limitations of the units themselves in a certain case.

The functions described herein above may be executed, at least in part, by one or more hardware logic components. For example, without limitation, example types of the hardware logic components that may be used include: a field programmable gate array (FPGA), an application specific integrated circuit (ASIC), application specific standard parts (ASSP), a system on chip (SOC), a complex programmable logic device (CPLD), and so on.

In the context of the present disclosure, a machine-readable medium may be a tangible medium, which may contain or store a program for use by or in combination with the instruction execution system, apparatus or device. The machine-readable medium may be a machine-readable signal medium or a machine-readable storage medium. The machine-readable medium may include, but is not limited to, an electronic, magnetic, optical, electromagnetic, infrared, or semiconductor system, apparatus or device, or any suitable combination thereof. Examples of the machine-readable storage medium would include an electrical connection based on one or more wires, a portable computer disk, a hard disk, an RAM, a ROM, an EPROM or a flash memory, an optical fiber, a CD-ROM, an optical storage device, a magnetic storage device, or any suitable combination thereof.

According to one or more embodiments of embodiments of the present disclosure, an embodiment of the present disclosure discloses a virtual object generation method, including:
acquiring a virtual object box to be mounted;
generating a reference line based on the virtual object box;
determining a position relationship between the reference line and a rendered virtual object;
processing the virtual object box according to the position relationship; and
generating a virtual object in the processed virtual object box.

According to one or more embodiments of the embodiments of the present disclosure, acquiring the virtual object box to be mounted includes:
performing object detection on the current picture; and
determining the virtual object box according to detected object.

According to one or more embodiments of the embodiments of the present disclosure, each virtual object box includes vertex information and central point information of the virtual object box, and there are a plurality of vertexes; and generating the reference line based on the virtual object box includes:
generating a plurality of reference lines respectively corresponding to the plurality of vertices and a central point.

According to one or more embodiments of the embodiments of the present disclosure, the position relationship include interaction and non-intersection, and determining the position relationship between the reference line and the rendered virtual object includes:

determining distances, to the rendered virtual object, from the plurality of reference lines respectively corresponding to the plurality of vertices and the central point;
if the distances are less than or equal to a set value, the reference lines intersect with the rendered virtual object; and if the distances are greater than the set value, the reference lines do not intersect with the rendered virtual object.

According to one or more embodiments of the embodiments of the present disclosure, processing the virtual object box according to the position relationship includes:
if the reference lines corresponding to the central point intersect with the rendered virtual object, deleting the virtual object box or lowering the transparency of the virtual object box; and
if the reference lines corresponding to the central point do not intersect with the rendered virtual object, and the reference lines corresponding to vertexes exceeding a set number intersect with the rendered virtual object, deleting the virtual object box or lowering the transparency of the virtual object box.

According to one or more embodiments of the embodiments of the present disclosure, determining the position relationship between the reference line and the rendered virtual object includes:
performing triangular meshing on the surface of the rendered virtual object, so as to obtain a plurality of triangular planes;
respectively determining intersection conditions between the reference lines and the
plurality of triangular planes; and
if the reference lines intersect with any triangular plane, the reference lines intersect with the rendered virtual object.

According to one or more embodiments of the embodiments of the present disclosure, determining the position relationship between the reference line and the rendered virtual object includes:
acquiring a bounding box of the rendered virtual object;
determining intersection conditions between the reference lines and the bounding box; and
if the reference lines intersect with the bounding box, the reference lines intersect with the rendered virtual object.

According to one or more embodiments of the embodiments of the present disclosure, the bounding box is a cuboid, and determining the intersection conditions between the reference lines and the bounding box includes:
acquiring three line segments obtained by the intersection of the reference lines with three pairs of parallel surfaces corresponding to the bounding box; and
if all the three line segments meet the following condition, the reference lines intersect with the bounding box:
a part or entirety of each line segment falls into the bounding box.

What is claimed is:

1. A virtual object generation method, comprising:
acquiring a virtual object box to be mounted;
generating a reference line based on the virtual object box;
determining a position relationship between the reference line and a rendered virtual object;
processing the virtual object box according to the position relationship; and
generating a virtual object in the processed virtual object box.

2. The method according to claim 1, wherein acquiring the virtual object box to be mounted comprises:
performing object detection on the current picture; and
determining the virtual object box according to detected object.

3. The method according to claim 1, wherein the virtual object box comprises vertex information and central point information of the virtual object box, and there are a plurality of vertexes; and generating the reference line based on the virtual object box comprises:
generating a plurality of reference lines respectively corresponding to the plurality of vertices and a central point.

4. The method according to claim 3, wherein the position relationship comprises interaction and non-intersection, and determining the position relationship between the reference line and the rendered virtual object comprises:
determining distances, to the rendered virtual object, from the plurality of reference lines respectively corresponding to the plurality of vertices and the central point;
in response to the distances being less than or equal to a set value, the reference lines corresponding to the distances intersect with the rendered virtual object; and in response to the distances being greater than the set value, the reference lines corresponding to the distances do not intersect with the rendered virtual object.

5. The method according to claim 4, wherein processing the virtual object box according to the position relationship comprises:
in a case that the reference lines corresponding to the central point intersect with the rendered virtual object, deleting the virtual object box or lowering the transparency of the virtual object box; and
in a case that the reference lines corresponding to the central point do not intersect with the rendered virtual object, and the reference lines corresponding to vertexes exceeding a set number intersect with the rendered virtual object, deleting the virtual object box or lowering the transparency of the virtual object box.

6. The method according to claim 4, wherein determining the position relationship between the reference line and the rendered virtual object comprises:
performing triangular meshing on the surface of the rendered virtual object, so as to obtain a plurality of triangular planes;
determining intersection conditions between the reference lines and the plurality of triangular planes respectively; and
in a case that the reference lines intersect with one triangular plane, the reference lines intersect with the rendered virtual object.

7. The method according to claim 4, wherein determining the position relationship between the reference line and the rendered virtual object comprises:
acquiring a bounding box of the rendered virtual object;
determining intersection conditions between the reference lines and the bounding box; and
in a case that the reference lines intersect with the bounding box, the reference lines intersect with the rendered virtual object.

8. The method according to claim 7, wherein the bounding box is a cuboid, and determining the intersection conditions between the reference lines and the bounding box comprises:
acquiring three line segments obtained by the intersection of the reference lines with three pairs of parallel surfaces corresponding to the bounding box; and
in the case that all the three line segments meet the following condition, the reference lines intersect with the bounding box:
a part or entirety of each line segment falls into the bounding box.

9-16. (canceled)

17. An electronic device, comprising:
at least one processing unit; and
a storage unit, configured to store at least one instruction that, when executed by the at least one processing unit, cause the electronic device at least to:
acquire a virtual object box to be mounted;
generate a reference line based on the virtual object box;
determine a position relationship between the reference line and a rendered virtual object;
process the virtual object box according to the position relationship; and
generate a virtual object in the processed virtual object box.

18. A non-transitory computer-readable medium, on which a computer program is stored, wherein the program implements, when being executed by a processing unit, the acts comprising:
acquiring a virtual object box to be mounted;
generating a reference line based on the virtual object box;
determining a position relationship between the reference line and a rendered virtual object;
processing the virtual object box according to the position relationship; and
generating a virtual object in the processed virtual object box.

19. (canceled)

20. The electronic device of claim 17, wherein the virtual object box comprises vertex information and central point information of the virtual object box, and there are a plurality of vertexes; and generating the reference line based on the virtual object box comprises:
generating a plurality of reference lines respectively corresponding to the plurality of vertices and a central point.

21. The electronic device of claim 20, wherein the position relationship comprises interaction and non-intersection, and determining the position relationship between the reference line and the rendered virtual object comprises:
determining distances, to the rendered virtual object, from the plurality of reference lines respectively corresponding to the plurality of vertices and the central point;
in response to the distances being less than or equal to a set value, the reference lines corresponding to the distances intersect with the rendered virtual object; and in response to the distances being greater than the set value, the reference lines corresponding to the distances do not intersect with the rendered virtual object.

22. The electronic device of claim 21, wherein processing the virtual object box according to the position relationship comprises:
in a case that the reference lines corresponding to the central point intersect with the rendered virtual object, deleting the virtual object box or lowering the transparency of the virtual object box; and
in a case that the reference lines corresponding to the central point do not intersect with the rendered virtual object, and the reference lines corresponding to vertexes exceeding a set number intersect with the rendered virtual object, deleting the virtual object box or lowering the transparency of the virtual object box.

23. The electronic device of claim 21, wherein determining the position relationship between the reference line and the rendered virtual object comprises:
performing triangular meshing on the surface of the rendered virtual object, so as to obtain a plurality of triangular planes;
determining intersection conditions between the reference lines and the plurality of triangular planes respectively; and
in a case that the reference lines intersect with one triangular plane, the reference lines intersect with the rendered virtual object.

24. The electronic device of claim 21, wherein determining the position relationship between the reference line and the rendered virtual object comprises:
acquiring a bounding box of the rendered virtual object;
determining intersection conditions between the reference lines and the bounding box; and
in a case that the reference lines intersect with the bounding box, the reference lines intersect with the rendered virtual object.

25. The non-transitory computer-readable medium of claim 18, wherein the virtual object box comprises vertex information and central point information of the virtual object box, and there are a plurality of vertexes; and generating the reference line based on the virtual object box comprises:
generating a plurality of reference lines respectively corresponding to the plurality of vertices and a central point.

26. The non-transitory computer-readable medium of claim 25, wherein the position relationship comprises interaction and non-intersection, and determining the position relationship between the reference line and the rendered virtual object comprises:
determining distances, to the rendered virtual object, from the plurality of reference lines respectively corresponding to the plurality of vertices and the central point;
in response to the distances being less than or equal to a set value, the reference lines corresponding to the distances intersect with the rendered virtual object; and in response to the distances being greater than the set value, the reference lines corresponding to the distances do not intersect with the rendered virtual object.

27. The non-transitory computer-readable medium of claim 26, wherein processing the virtual object box according to the position relationship comprises:
in a case that the reference lines corresponding to the central point intersect with the rendered virtual object, deleting the virtual object box or lowering the transparency of the virtual object box; and
in a case that the reference lines corresponding to the central point do not intersect with the rendered virtual object, and the reference lines corresponding to vertexes exceeding a set number intersect with the rendered virtual object, deleting the virtual object box or lowering the transparency of the virtual object box.

28. The non-transitory computer-readable medium of claim 26, wherein determining the position relationship between the reference line and the rendered virtual object comprises:
performing triangular meshing on the surface of the rendered virtual object, so as to obtain a plurality of triangular planes;
determining intersection conditions between the reference lines and the plurality of triangular planes respectively; and
in a case that the reference lines intersect with one triangular plane, the reference lines intersect with the rendered virtual object.

29. The non-transitory computer-readable medium of claim 26, wherein determining the position relationship between the reference line and the rendered virtual object comprises:
acquiring a bounding box of the rendered virtual object;
determining intersection conditions between the reference lines and the bounding box; and
in a case that the reference lines intersect with the bounding box, the reference lines intersect with the rendered virtual object.
